(19) United States
(12) Patent Application Publication
(10) Pub. No.: US 2005/0117584 A1
(43) Pub. Date: Jun. 2, 2005

(54) Multi-channel job scheduling apparatus and method for communication system

(75) Inventor: Chul-min Kim, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/998,545

(22) Filed: Nov. 30, 2004

(30) Foreign Application Priority Data
Dec. 1, 2003 (KR) 2003-86504

(51) Int. Cl. H04L 12/56

(52) U.S. Cl. 370/395.4

(57) ABSTRACT

A multi-channel job scheduling method, and a multi-channel job scheduling apparatus including a plurality of channels; an event scheduling unit including a quantity of event schedulers equal to a quantity of the channels, to process events in parallel using the channels; and an event source unit including a plurality of event sources; wherein any one of the plurality of event sources issues a request, in response to an event occurring in the one event source, to one of the event schedulers to use one of the channels allotted to the event, and then processes the event.

### CROSS-REFERENCE TO RELATED APPLICATIONS

This application claims the priority of Korean Patent Application No. 2003-86504, filed on Dec. 1, 2003, in the Korean Intellectual Property Office, the disclosure of which is incorporated herein in its entirety by reference.

### BACKGROUND OF THE INVENTION

1. Field of the Invention

The present invention relates to a communication system, and, more particularly, to a multi-channel job scheduling apparatus and method for a transport layer.

2. Description of the Related Art

A transport layer is one layer of an open system interconnection (OSI) standard. The OSI standard, which is a standard for a communication protocol defined by the International Standards Organization (ISO), divides the communication protocol into a physical layer, a data link layer, a network layer, a presentation layer, a session layer, a transport layer, and an application layer.

Transmission control protocol (TCP), which is a protocol for the transport layer, has been embodied as Mbps-level software. In recent years, however, data transmission rates have rapidly increased to more than Gbps level. In this regard, the transport layer is likely to constitute a bottle neck section in a communication. For example, high-speed real-time communication services, such as video streaming, cannot be satisfactorily provided due to such low processing speed of TCP.

In order to solve this problem, research has been carried out on methods to realize TCP algorithms as hardware. Hardware TCP is believed to more efficiently improve overall data processing speed than software TCP by reducing unnecessary memory access overhead and checksum overhead.

The hardware TCP, however, inherits most of the prominent traits of conventional software TCP based on single thread & time division multiplexing technology. Therefore, even though a plurality of events occur simultaneously, the hardware TCP cannot process the plurality of events in parallel, but performs job scheduling on a one-event-per-channel basis.

However, in reality, multiple events, each of which requires a memory copy cycle with a huge overhead, can simultaneously take place via different channels. For example, an event for recording several thousands of bytes of TX data in a memory, an event for reading several thousands of bytes of RX data from a memory, an event for performing check sum for several thousands of bytes of TX data, and an event for consecutively generating the above three events may take place at the same time via different channels.

In a case where such events occur at the same time via different channels, the hardware TCP controls event sources, except for the one that currently occupies a predetermined event scheduler for job scheduling, to be in a standby mode until the predetermined event scheduler is set to an idle state. Therefore, it is difficult to effectively handle multiple events occurring in multiple channels using the hardware TCP.

### SUMMARY OF THE INVENTION

The present invention provides a multi-channel job scheduling apparatus and a method for a communication system, which process, in parallel, multiple events occurring in a transport layer of the communication system.

The present invention also provides a multi-channel job scheduling apparatus and method for a communication system, which process, in parallel, multiple events occurring in multiple channels in a transport layer of the communication system.

Additional aspects and/or advantages of the invention will be set forth in part in the description which follows and, in part, will be obvious from the description, or may be learned by practice of the invention.

According to an aspect of the present invention, there is provided a multi-channel job scheduling apparatus. The multi-channel job scheduling apparatus includes an event scheduling unit comprising a plurality of event schedulers to process a plurality of events in parallel using different channels; a channel flag to manage channel state information based on an operating state of each of the event schedulers; an event scheduler flag to manage information regarding the operating state of each of the event schedulers; and an event source unit comprising a plurality of event sources, wherein any one of the plurality of event sources issues a request, in response to an event occurring in the one event source, to one of the event schedulers to use one of the channels based on the channel flag and the event scheduler flag and then appropriately processes the event.

According to another aspect of the present invention, there is provided a multi-channel job scheduling apparatus comprising a plurality of channels, an event scheduling unit comprising a quantity of event schedulers equal to a quantity of the channels, to process events in parallel using the channels; and an event source unitcomprising a plurality of event sources, wherein any one of the plurality of event sources issues a request, in response to an event occurring in the one event source, to one of the event schedulers to use one of the channels allotted to the event, and then processes the event.

According to another aspect of the present invention, there is provided a multi-channel job scheduling method for a communication system which comprises a channel flag to manage state information of a plurality of channels, a plurality of event schedulers, an event scheduler flag to manage information regarding an operating state of each of the event schedulers, and a plurality of event sources, the multi-channel job scheduling method comprising deterimining, at any one of the event sources, whether a channel is available by referring to the channel flag in response to an event occurring; issuing, at the one of the event sources, a request to use the channel to one of the event schedulers that is currently available by referring to the event scheduler flag, in response to deteriming the corresponding channel is available; and processing the event at the one of the event sources in response to the one of the event sources receiving a signal that grants the one of the event sources use of the channel.

According to another aspect of the present invention, there is provided a multi-channel job scheduling method for a communication system, which comprises a quantity of event schedulers equal to a quantity of channels, the multi-channel job scheduling method comprising issuing, at an event source, a request to use a predetermined channel to one of the event schedulers corresponding to the predetermined channel allotted to an event in response to the event occurring; processing the event at the event source in response to the event source receiving a signal that grants the event source use of the predetermined channel from the event scheduler; and setting the event scheduler to an idle state in response to the processing of the event being complete.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a multi-channel job scheduling apparatus for a communication system, according to an embodiment of the present invention;

FIG. 2 is a flowchart of a multi-channel job scheduling method for a communication system, according to an embodiment of the present invention;

FIG. 3 is a block diagram of a multi-channel job scheduling apparatus for a communication system, according to another embodiment of the present invention;

FIG. 4 is a detailed block diagram of an event scheduler of FIG. 3; and

FIG. 5 is a flowchart of a multi-channel job scheduling method for a communication system, according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

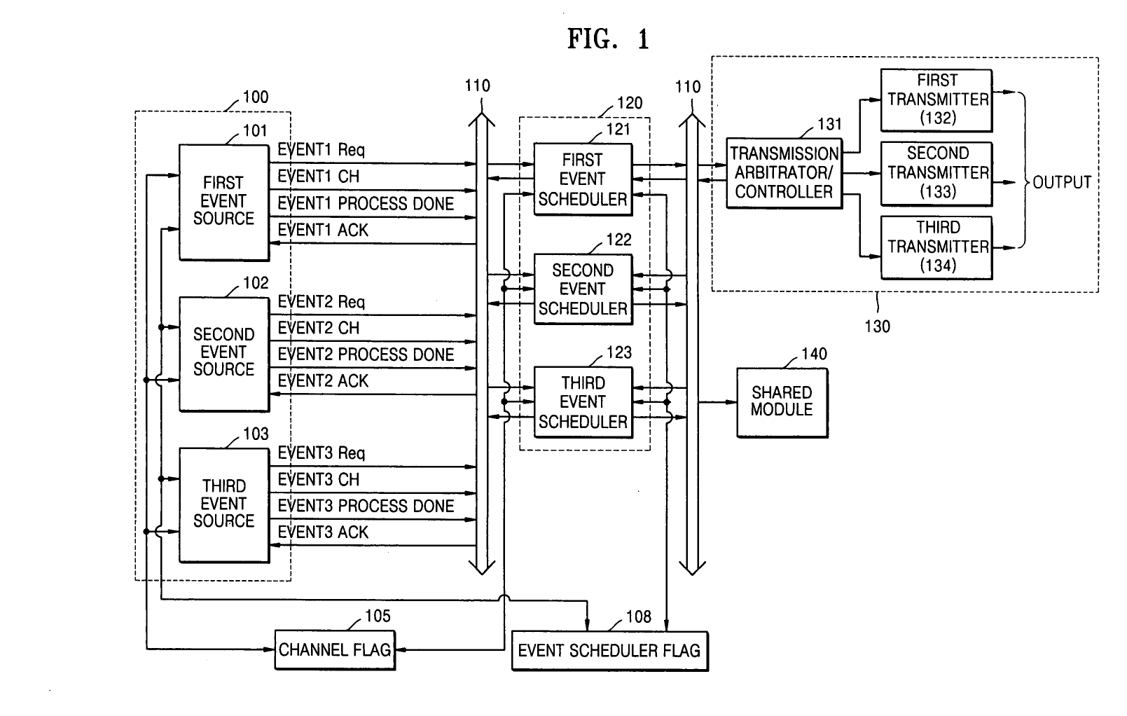

FIG. 1 is a block diagram of a multi-channel job scheduling apparatus for a communication system, according to an embodiment of the present invention. Referring to FIG. 1, the apparatus includes an event source unit 100, a channel flag 105, an event scheduler flag 108, a common bus 110, an event scheduling unit 120, a multi-channel transmitting module 130, and a shared module 140.

The event source unit 100 includes a plurality of event sources, i.e., first through third event sources 101 through 103. Each of the first through third event sources 101 through 103 may be, for example, a user interface module, a packet receiving module, or a timer.

When an event occurs, each of the first through third event sources 101 through 103 determines whether a predetermined channel is currently available for the event by referring to the channel flag 105, and selects an event scheduler that is currently available from first through third event schedulers 121 through 123 by referring to the event scheduler flag 108.

For example, if the predetermined channel is available for an event that has occurred in the first event source 101, the first event source 101 selects the event scheduler that is currently available from the first through third event schedulers 121 through 123 by referring to the event scheduler flag 108, issues a request EVENT1 Req for granting a right to use the predetermined channel to the selected event scheduler. When the first event source 101 receives a grant signal EVENT1 ACK from the selected event scheduler, it processes the event appropriately. More specifically, if the first event source 101 is a user interface module, it processes the event, i.e., packet data, from the first event source 101 to the outside, or records the packet data in the shared module 140. If the first event source 101 is a timer, it periodically updates timer variables used in, for example, a transport layer.

When the first event source 101 completes the processing of the event, it outputs a process end signal EVENT1 PROCESS DONE to the selected event scheduler.

The channel flag 105 manages information of the state of all channels in the transport layer based on an operating state of the event scheduling unit 120. For example, supposing that there are eight channels in the transport layer, the channel flag 105 stores state information of each of the eight channels. Therefore, it may be determined whether each of the eight channels is available based on the state information of each of the eight channels. In this case, the channel flag 105 may be comprised of 8 bits.

The channel flag 105 manages the state information of each of the channels in the transport layer by regarding channels currently being used by the first through third event schedulers 121 through 123 as being busy. By doing so, it is possible to prevent two or more event sources from attempting to access one channel at the same time. Information contained in the channel flag 105 is updated by each of the first through third event schedulers 121 through 123.

The event scheduler flag 108 provides the first through third event sources 101 through 103 with predetermined information so that they can determine which event scheduler, among the first through third event schedulers 121 through 123, is currently available. Therefore, it is possible to prevent two or more event sources from attempting to occupy one event scheduler. The number of bits used for defining the event scheduler flag 108 may be determined depending on the number of event schedulers included in the event scheduling unit 120.

The event scheduler flag 108 manages information on the state of each of the first through third event schedulers 121 through 123. Therefore, it may be determined whether each of the first through third event schedulers 121 through 123 is in an idle state or busy state by referring to the event scheduler flag 108. Information contained in the event scheduler flag 108 is updated by each of the first through third event schedulers 121 through 123.

All signals transmitted between the first through third event sources 101 through 103 and the first through third event schedulers 121 through 123 pass through the common bus 110. In addition, all signals transmitted between the first through third event schedulers 121 through 123 and the shared module 140, and control signals transmitted between the first through third event schedulers 121 through 123 and the multi-channel transmitting module 130, also pass through the common bus 110.

The event scheduling unit 120 includes the first through third event schedulers 121 through 123. The number of event schedulers included in the event scheduling unit 120 is the same as the number of event sources included in the event source unit 100. The event scheduling unit 120 processes, in parallel, multiple events, which are respectively allotted to different channels, by using the first through third event schedulers 121 through 123. In other words, the first through third event schedulers 121 through 123 perform job scheduling so that the multiple events can respectively occupy different channels in the transport layer but can be simultaneously processed.

The multi-channel transmitting module 130 has multiple channels so that it can allot the multiple channels to different event sources, respectively. More specifically, in order to respectively allot channels to the first through third event sources 101 through 103, the multi-channel transmitting module 130 includes a transmission arbitrator/controller 131 and first through third transmitters 132 through 134. The first through third transmitters 132 through 134 are independent of one another.

The transmission arbitrator/controller 131 calculates the number of bytes of data transmitted from the event scheduling unit 120 via the common bus 110, controls the format of the data, and transmits the data to one of the first through third transmitters 132 through 134.

Each of the first through third transmitters 132 through 134 copies data received from the transmission arbitrator/controller 131 into a memory. Alternatively, each of the first through third transmitters 132 through 134 transmits the received data to the outside. Each of the first through third transmitters 132 though 134 may include the memory.

The shared module 140 is shared by the first through third event sources 101 through 103. The first through third event sources 101 through 103 are allowed to access the shared module 140 at the same time but from different channels. The shared module 140 can be a memory.

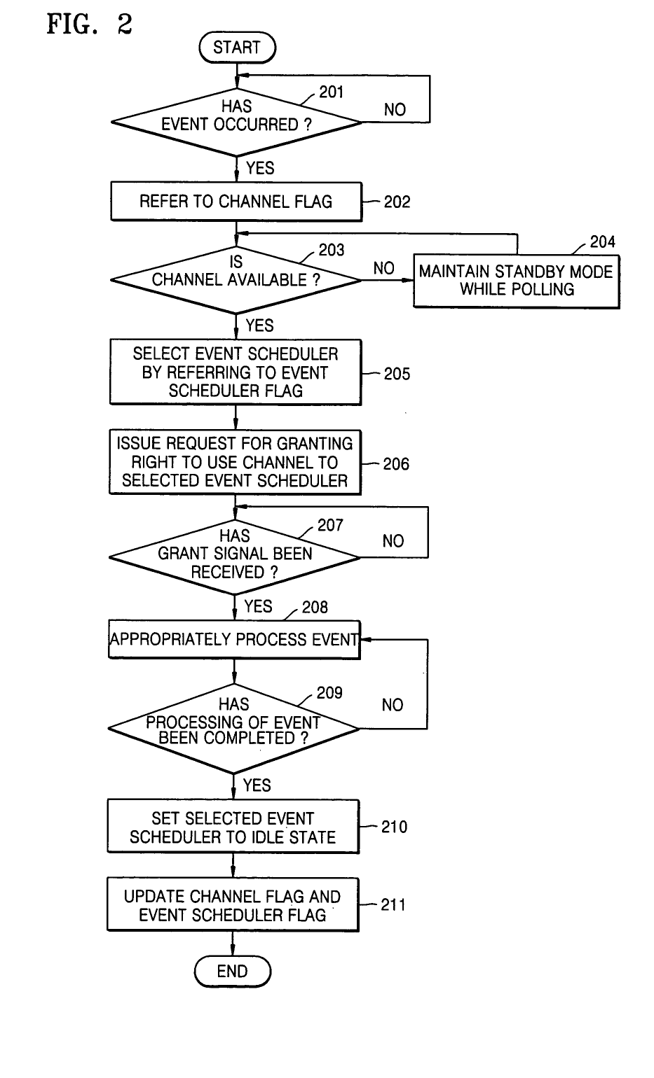

FIG. 2 is a flowchart of a multi-channel job scheduling method for a communication system, according to an embodiment of the present invention. Referring to FIG. 2, when an event occurs in operation 201, an event source where the event takes place refers to the channel flag 105 in operation 202.

If a predetermined channel allotted to the event source is determined as unavailable in operation 203, the event source maintains a standby state while polling the channel flag 105 in operation 204. If the channel flag 105 shows that the predetermined channel is in a busy state, the predetermined channel is considered as unavailable.

If the predetermined channel is determined as being in an idle state in operation 203, the event source selects one of the first through third event schedulers 121 through 123 in operation 205 by referring to the event scheduler flag 108. Since as many event schedulers as there are event sources in the event source unit 100 are disposed in the event scheduling unit 120, at least one of the first through third event schedulers 121 through 123 is likely to be in an idle state when an event occurs in the event source.

In operation 206, the event source issues a request for granting the right to use the predetermined channel to the selected event scheduler. When a grant signal is received from the selected event scheduler in operation 207, the event source processes the event that has occurred therein in operation 208.

If the processing of the event is determined as being completed in operation 209, the selected event scheduler is set to an idle state in operation 210. In operation 211, the channel flag 105 and the event scheduler flag 108 are updated, thereby finishing the entire multi-channel job scheduling process. The channel flag 105 and the event scheduler flag 108 are updated so that the predetermined channel and the selected event scheduler can be set to an idle state.

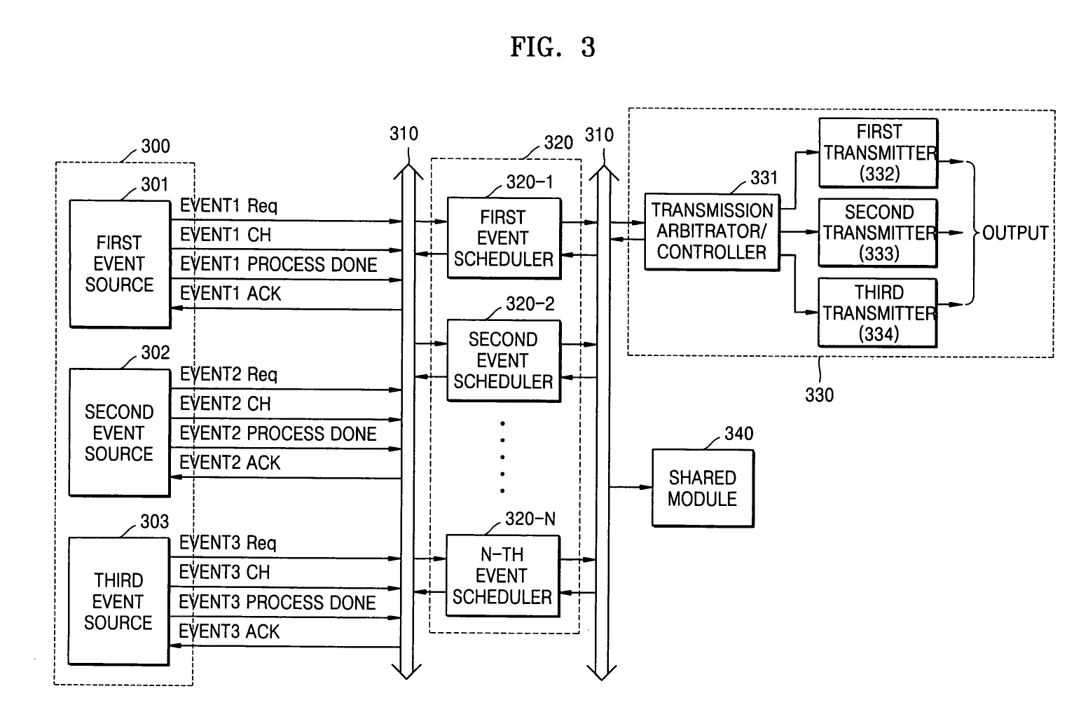

FIG. 3 is a block diagram of a multi-channel job scheduling apparatus for a communication system, according to another embodiment of the present invention. Referring to FIG. 3, the apparatus includes an event source unit 300, a common bus 310, an event scheduling unit 320, a multi-channel transmitting module 330, and a shared module 340.

The event source unit 300, like the event source unit 100 of FIG. 1, includes first through third event sources 301 through 303. The multi-channel transmitting module 330, like the multi-channel transmitting module 130 of FIG. 1, includes first through third transmitters 332 through 334. The common bus 310 and the shared module 340 are the same as their respective counterparts of FIG. 1.

The event scheduling unit 320 respectively allots event schedulers to different channels in order to process multiple events in parallel. The event scheduling unit 320 includes as many event schedulers as there are channels disposed in the communication system. Therefore, if the event scheduling unit 320 includes first through N-th event schedulers 320-1 through 320-N, then there are N channels disposed in the communication system. For example, if there are eight channels disposed in the communication system, the event scheduling unit 320 includes eight event schedulers.

When an event occurs in the first event source 301, the first event source 301 issues a request for granting a right to use a predetermined channel to an event scheduler corresponding to the predetermined channel. For example, if the predetermined channel is the first one, the first event source 301 issues the request for granting the right to use the predetermined channel to the first event scheduler 320-1 via the common bus 310.

If the first event scheduler 320-1 is not available, the first event source 301 maintains a standby state until it receives a grant signal from the first event scheduler 320-1. Otherwise, the first event source 301 receives the grant signal from the first event scheduler 320-1 and then appropriately processes the event that has occurred therein.

When the processing of the event is complete, the first event source 301 sends a process end signal EVENT1 PROCESS DONE to the first event scheduler 320-1. In response to the process end signal EVENT1 PROCESS DONE, the first event scheduler 320-1 is set to an idle state so that it can perform job scheduling for events other than the one that has already occurred.

If the event that has occurred in the first event source 301 corresponds to an N-th channel, the first event source 301 issues a request for granting a right to use the N-th channel to the N-th event scheduler 320-N.

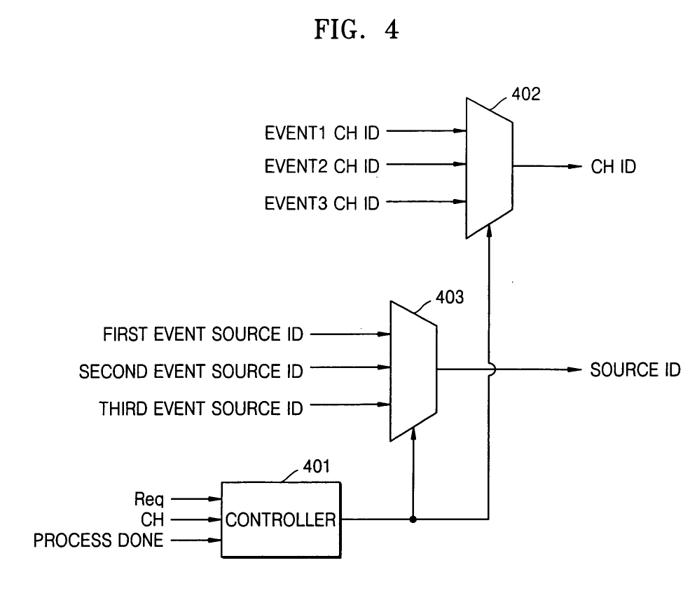

FIG. 4 is a detailed block diagram of each of the first through N-th event schedulers 320-1 through 320-N of FIG. 3. Referring to FIG. 4, each of the first through N-th event schedulers 320-1 through 320-N includes a controller 401, a multiplexer 402 for channel identifications (IDs), and a multiplexer 403 for event source IDs.

The controller 401 controls the operation of the multiplexers 402 and 403 by transmitting a control signal to one of the first through third event sources 301 through 303, which has issued a request for granting a right to use a predetermined channel to the controller 401.

The channel ID is information used for identifying a channel corresponding to an event occurring in one of the first through third event sources 301 through 303. The first through third event sources 301 through 303 provide channel IDs EVENT1 CH, EVENT2 CH, and EVENT3 CH, respectively. An event source ID is information used for identifying each of the first through third event sources 301 through 303. Event source IDs can be included in requests for granting a right to use the predetermined channel, i.e., EVENT1 Req, EVENT2 Req, and Event3 Req, respectively.

A channel ID and an event source ID selected by the multiplexers 402 and 403, respectively, are transmitted to the multi-channel transmitting module 330 or the shared module 340 via the common bus 310.

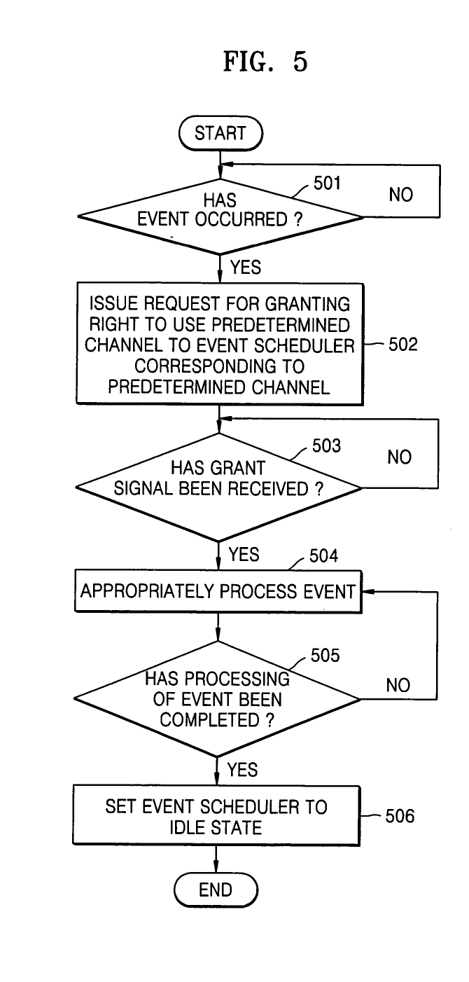

FIG. 5 is a flowchart of a multi-channel job scheduling method for a communication system, according to another embodiment of the present invention. Referring to FIG. 5, when an event occurs in operation 501, an event source where the event takes place issues a request for granting a right to use a predetermined channel to an event scheduler corresponding to the predetermined channel of the event in operation 502. The plurality of event schedulers are allotted to different channels.

When the event source receives a grant signal from the event scheduler in operation 503, it processes the event appropriately in operation 504. If the grant signal has not yet been received from the event scheduler, the event source maintains a standby state until it receives the grant signal from the event scheduler.

When the processing of the event is complete in operation 505, the event source outputs a process end signal PROCESS DONE to the event scheduler, sets the event scheduler to an idle state, and ends the multi-channel job scheduling process in operation 506.

As described above, according to the present invention, it is possible to process, in parallel, multiple events, simultaneously occurring in different channels, independently of each other. Thus, it is possible to process multiple events in a transport layer in real time without delays.

In addition, it is possible to dramatically improve the operation of the transport layer, which was inefficient in the conventional art, by preventing events, each of which requires a memory copy cycle with a huge overhead, from attempting to occupy a single event scheduler. Moreover, it is possible to design an improved hardware transmission control protocol (TCP) using a multi-channel job scheduler.

Although a few embodiments of the present invention have been shown and described, it would be appreciated by those skilled in the art that changes may be made in these embodiments without departing from the principles and spirit of the invention, the scope of which is defined in the claims and their equivalents.

1. A multi-channel job scheduling apparatus comprising:
an event scheduling unit comprising a plurality of event schedulers to process a plurality of events in parallel using different channels;
a channel flag to manage channel state information based on an operating state of each of the event schedulers;
an event scheduler flag to manage information regarding the operating state of each of the event schedulers; and
an event source unit comprising a plurality of event sources;
wherein any one of the plurality of event sources issues a request, in response to an event occurring in the one event source, to one of the event schedulers to use one of the channels based on the channel flag and the event scheduler flag, and then appropriately processes the event.

2. The multi-channel job scheduling apparatus of claim 1, wherein a quantity of the event schedulers is the same as a quantity of the event sources.

3. The multi-channel job scheduling apparatus of claim 1, further comprising a multi-channel transmitting unit to allot the respective channels to each of the plurality of event sources.

4. The multi-channel job scheduling apparatus of claim 3, wherein the multi-channel transmitting unit comprises:
a plurality of transmitters; and
a transmission arbitrator/controller to control the plurality of transmitters to allot the respective channels to each of the event sources.

5. The multi-channel job scheduling apparatus of claim 4, wherein each of the transmitters is independent of the remaining transmitters.

6. The multi-channel job scheduling apparatus of claim 1, wherein each of the event schedulers comprises:
a first multiplexer to identify the channels;
a second multiplexer to identify the event sources; and
a controller to control the first and second multiplexers by transmitting a control signal to the event source issuing the request to use one of the channels.

7. The multi-channel job scheduling apparatus of claim 1, further comprising a common bus to connect the event source unit and event scheduling unit.

8. The multi-channel job scheduling apparatus of claim 1, wherein the event sources comprise at least one of a user interface module, a packet receiving module, or a timer.

9. The multi-channel job scheduling apparatus of claim 1, wherein the channel flag manages the channel state information of each of the channels by regarding channels currently being used by the event schedulers as being busy.

10. The multi-channel job scheduling apparatus of claim 1, wherein the channel state information in the channel flag is updated by each of the event schedulers.

11. The multi-channel job scheduling apparatus of claim 1, wherein a quantity of the event schedulers in the event scheduling unit is equal to a quantity of the event sources in the event source unit.

12. A multi-channel job scheduling apparatus comprising:
a plurality of channels;
an event scheduling unit comprising a quantity of event schedulers equal to a quantity of the channels, to process events in parallel using the channels; and
an event source unit comprising a plurality of event sources;
wherein any one of the plurality of event sources issues a request, in response to an event occurring in the one event source, to one of the event schedulers to use one of the channels allotted to the event, and then processes the event.

13. The multi-channel job scheduling apparatus of claim 12, further comprising a multi-channel transmitting unit to allot the respective channels to each of the plurality of event sources,
wherein the multi-channel transmitting unit is controlled by the plurality of event schedulers.

14. A multi-channel job scheduling method for a communication system which comprises a channel flag to manage state information of a plurality of channels, a plurality of event schedulers, an event scheduler flag to manage information regarding an operating state of each of the event schedulers, and a plurality of event sources, the multi-channel job scheduling method comprising:
determining, at any one of the event sources, whether a channel is available by referring to the channel flag in response to an event occurring;
issuing, at the one of the event sources, a request to use the channel to one of the event schedulers that is currently available by referring to the event scheduler flag, in response to determining the corresponding channel is available; and
processing the event at the one of the event sources in response to the one of the event sources receiving a signal that grants the one of the event sources use of the channel.

15. The multi-channel job scheduling method of claim 14, further comprising setting the event scheduler to an idle state in response to the processing of the event being complete, and updating the state information in the channel flag and the information in the event scheduler flag.

16. A multi-channel job scheduling method for a communication system which comprises a quantity of event schedulers equal to a quantity of channels, the multi-channel job scheduling method comprising:
issuing, at an event source, a request to use a predetermined channel to one of the event schedulers corresponding to the predetermined channel allotted to an event in response to the event occurring;
processing the event at the event source in response to the event source receiving a signal that grants the event source use of the predetermined channel from the event scheduler; and
setting the event scheduler to an idle state in response to the processing of the event being complete.

17. A multi-channel job scheduling apparatus comprising:
a plurality of event schedulers to process events in parallel using a plurality of channels; and
a plurality of event sources, any one of which issues a request to one of the event schedulers, in response to an event occurring in the one event source, to use one of the channels.

18. The multi-channel job scheduling apparatus of claim 17, wherein the one event source processes the event in response to being allowed use of the one of the channels.

19. The multi-channel job scheduling apparatus of claim 17, wherein a quantity of the event schedulers is equal to a quantity of the event sources.

20. The multi-channel job scheduling apparatus of claim 17, further comprising a channel flag to manage channel state information of each of the event schedulers.

21. The multi-channel job scheduling apparatus of claim 20, further comprising an event scheduler flag to manage information regarding an operating state of each of the event schedulers.

22. The multi-channel job scheduling apparatus of claim 21, wherein the request by any one of the event sources is based on the channel flag and the event scheduler flag.

23. A multi-channel job scheduling apparatus comprising:
a plurality of event schedulers to process events in parallel using a plurality of channels;
wherein more than one of the events cannot occupy any one of the event schedulers simultaneously.
